(19) United States
(12) Patent Application Publication
(10) Pub. No.: US 2019/0328017 A1
(43) Pub. Date: Oct. 31, 2019

(54) METHOD FOR PRODUCING A CULINARY CONDIMENT WITH DUNALIELLA SALINA AND SEA SALT

(71) Applicant: INSTITUTO TECNOLOGICO DE CANARIAS, S.A. (ITC), Las Palmas (ES)

(72) Inventors: Eduardo PORTILLO HAHNAFELD, Las Palmas (ES); Antonio SUAREZ VEGA, Las Palmas (ES); Hector MENDOZA GUZMAN, Las Palmas (ES); Adelina DE LA JARA VALIDO, Las Palmas (ES); Karen FREIJANES PRESMANES, Las Palmas (ES); Patricia Alexandra CLEMENTE JANEIRO ASSUNCAO, Las Palmas (ES); David RODRIGUEZ ESTUPINAN, Las Palmas (ES)

(21) Appl. No.: 16/462,151

(22) PCT Filed: Nov. 17, 2017
(86) PCT No.: PCT/EP2017/079540

§ 371 Date: May 17, 2019

(30) Foreign Application Priority Data
Nov. 18, 2016 (ES) P 201631488

(51) Int. Cl. A23L 27/40; A23L 33/105; A23P 30/00

(52) U.S. Cl. CPC A23L 27/40; A23P 30/00; A23L 33/105

(57) ABSTRACT

Method for producing a culinary condiment with Dunaliella salina and sea salt is provided by: incorporating Dunaliella salina in live state in the evaporation of sea salt, and carrying out joint crystallization of both components by a continuous dripping system which allows this microalgae to be encapsulated in the salt, a condiment being obtained with a high content of β-carotene, a culinary condiment based on Dunaliella salina and sea salt, and use of the present condiment in the food and restaurant industry.

### OBJECT OF THE INVENTION

The present invention relates to a method for producing a culinary condiment with Dunaliella salina and sea salt which has a high content of β carotenes.

The present object belongs to the sector of the food industry, specifically that which is directed at producing culinary condiments and additives which are used in the preparation and enrichment of food products.

### BACKGROUND OF THE INVENTION

A condiment is normally required in culinary preparations which boosts or enhances the intrinsic flavor of the food during its consumption. For example, sea salt, salt/pepper mixture, salt, parsley and garlic mixture, dehydrated algae, amongst other mixtures of condiments. It is important for this condiment to be incorporated into the food product in the correct and suitable dose from the point of view of the health of individuals and from an organoleptic point of view.

At present in the food industry, there is a need for new culinary condiments or mixtures of condiments which, following their incorporation and mixing, provide the food preparations with greater nutritional value. One example of the foregoing is the use of algae, microalgae and similar, as bioactive ingredients when producing food products.

It is known that microalgae constitute a natural reserve for the development and design of new foods. For example, it is known that Dunaliella salina is a microalgae which intracellularly synthesizes and accumulates large quantities of β carotene isomers in a hyper saline medium (halophilic microorganism) with high exposure to sun light and at high temperatures.

The microalgae Dunaliella salina, in addition to being known for its very high tolerance to hypersaline media, has significant antioxidant activity which makes it interesting for applying in the food, cosmetics and pharmaceutical industries.

In the food industry, in the preparation and design of culinary condiments, the incorporation of Dunaliella salina is not viable in current practice. If this microalgae is dehydrated and/or lyophilized, as is done in current different processes, the β carotene ends up degrading through enzymatic action, exposure to light and to oxygen and, even more quickly, in the presence of salt due to the fact that the oxidative reactions are accelerated (less than 30 days).

The present invention is directed at resolving the problem cited above and meeting the need for a new condiment with a high content of β carotenes; in this case, the invention proposes the preparation of a condiment with Dunaliella salina, which is present in an integral and lasting manner, and sea salt.

### DESCRIPTION OF THE INVENTION

Sea salt which is traditionally obtained from coastal salts is generated in the evaporation ponds together with this microalgae, coloring the salt produced with a pink tonality. The evaporation ponds are tide-pools or generally rectangular enclosures, with shallow depth in which the natural evaporation of the sea water is produced. When the sea water deposited in these evaporation ponds reaches crystallization salinity, it usually has a high density of these microalgae as well as a high concentration of β carotene. However, in the traditional process for collecting salt, by dragging shovels, fleur de sel, by surface filtration as well as washing which are carried out to preserve optimal sanitary hygienic conditions of the salt prepared, this microalgae is removed from the final product.

Alternatively, considering the processes existing at present in the prior art, the present invention develops a joint crystallization process (salt and microalgae) in the mentioned ponds, which allows the microalgae biomass to be integrated, in integral cellular state, inside the salt.

Integral cellular state is understood as the state in which the cell walls of the microalgae are maintained intact, without breaking, and, therefore, there is no outlet nor substantial modification of its intracellular content.

This process is carried out by means of a pallet system (system formed by multiple rotary pallet wheels partially submerged in water which are arranged and coupled in a non-permanent manner via a rotary cylindrical bar which are actuated by renewable energy, wind and solar) with continuous and slow movement (less than 10 revolutions per minute). The pallets are introduced barely a few millimeters into the surface of the hypersaline water and central part of the pond, forming, at its edges and along the entire width of the same, a continuous dripping which ends jointly precipitating the salt and the algae biomass in live state (incorporation of Dunaliella salina in the salt).

In this process of precipitation by continuous dripping, the microalgae, due to the effects of the crystallization, is compressed and reduced, but allows the cell integrity to be preserved, in particular the cell wall. In this way, the degradation of the β carotene is prevented since it is protected inside the microalgae as a natural organic pigment.

Therefore, using the present method, the live cell is encapsulated, remains trapped, in the salt. Thus, the method allows the cell integrity of Dunaliella salina to be maintained or safeguarded and prevents the degradation of intracellular β carotene since it is protected inside the microalgae and allows its use as a natural organic pigment.

The production method concludes with the packaging and storage of the condiment, prior to its distribution.

The invention provides a culinary condiment which, obtained by means of a production method defined as described above, comprises Dunaliella salina and sea salt. Considering that the microalgae remains in integral cellular state in the salt, the present condiments provides characteristic and different color, aroma and flavor, both to the salt and to the cooked and semi-prepared foods which incorporate it, which will be maintained and preserved with the passing of time.

The condiment obtained here is generally used in the food industry and, in particular in restaurant establishments as a natural colorant due to its high content of β carotene (E160a) and as a flavoring and flavor enhancer of foods cooked and prepared therewith.

Among the advantages of the present method over the traditional processes, are the following, amongst others:
Dunaliella salina is stably mixed in live state with sea salt, without degradation of intracellular β carotene,
live cells of this microalgae are incorporated into the sea salt and are encapsulated, conserving their cellular integrity, and
a new condiment based on Dunaliella salina and sea salt is obtained.

### Exemplary Embodiment

In order to carry out the method of the present invention, as described above, a modular (wheels independent of each other) and mobile (transportable from one pond to another) system of pallets (system described above) is used. In this case, it is transported to the ponds of a traditional saline coast where there is naturally a high concentration of Dunaliella salina and where the medium has reached a crystallization salinity greater than 250 g/l.

In this way, (with the rotary pallet wheels and immersion of the edges of the same) the water can be stirred and all the salt from the pond with Dunaliella salina incorporated is precipitated on the surface of the pallets (step for incorporating the microalgae in the salt).

Once this reddish salt with Dunaliella salina on the pallets has been collected from the pond, the stirring system is taken away to the processing room to scrape the blades with a type of spatula system and remove the salt from the same and restart the process in another pond in optimal conditions for successively developing said process.

The sea salt with Dunaliella salina incorporated, said culinary condiment being packaged and stored for its distribution to different entities of the food industry, centers and restaurant establishments, etc.

1.-3. (canceled)

4. A method for producing a culinary condiment by joint crystallization of salt and the microalga Dunaliella salina in sea salt evaporation ponds, which allows the microalgae biomass to be integrated, in integral cellular state, inside the salt, comprising:
introducing in a central part of a sea evaporation pond and partially submerging into a surface of hypersaline water, while continuously and slowly moving multiple rotary paddle wheels arranged and coupled in a non-permanent manner via a rotary cylindrical bar, actuated by renewable energy, wherein the continuous and slow movement is of less than 10 revolutions per minute,
wherein the paddles are introduced in the central part of a sea evaporation pond and partially submerged into the surface of the hypersaline water, forming, at their edges and along the entire width of the paddles, a continuous dripping which gives rise to the joint precipitation of the salt and the microalgae biomass in live state,
wherein in said sea salt evaporation pond there is naturally a high concentration of Dunaliella salina and the medium has reached a crystallization salinity greater than 250 g/L.

5. A system for producing a culinary condiment by joint crystallization of salt and the microalga Dunaliella salina in sea salt evaporation ponds, which allows the microalgae biomass to be integrated, in integral cellular state, inside the salt, comprising:
multiple rotary paddle wheels arranged and coupled in a non-permanent manner via a rotary cylindrical bar, actuated by renewable energy with continuous and slow movement of less than 10 revolutions per minute,
wherein the paddles are introduced in the central part of a sea evaporation pond and partially submerged into the surface of the hypersaline water, forming, at their edges and along the entire width of the paddles, a continuous dripping which gives rise to the joint precipitation of the salt and the microalgae biomass in live state,
wherein in said sea salt evaporation pond there is naturally a high concentration of Dunaliella salina and the medium has reached a crystallization salinity greater than 250 g/L.

6. The method according to claim 4, wherein the renewably energy is wind or solar power.

7. The system according to claim 5, wherein the renewably energy is wind or solar power.
